(19) United States
(12) Patent Application Publication
(10) Pub. No.: US 2004/0203974 A1
(43) Pub. Date: Oct. 14, 2004

(54) Method and wireless device for providing a maintenance notification for a maintenance activity

(76) Inventor: Michael A. Seibel, Capron, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/175,371

(22) Filed: Jun. 19, 2002

(51) Int. Cl. H04B 5/00; H04M 3/42; H04B 7/00; H04Q 7/20

(52) U.S. Cl. 455/517; 455/41.2; 455/414.1

(57) ABSTRACT

A method (500) and a wireless device (110) for providing a maintenance notification associated with a vehicle (120) are described herein. The wireless device (110) may generate a notification request based on a user input or automatically generate the notification request. The notification request may include, but is not limited to, information associated with a trigger event for a maintenance activity associated with the vehicle (120). The wireless device (110) may transmit the notification request to the vehicle (120) via a first communication link (130). Based on detection of the trigger event by the vehicle (120), the wireless device (110) may receive a maintenance notification for the maintenance activity. Further, the wireless device (110) may store the maintenance notification in a date book stored within the wireless device (110).

### TECHNICAL FIELD

The present disclosure relates to wireless communication systems, and more particularly, to a method and a wireless device for providing a maintenance notification for a maintenance activity associated with a vehicle.

### BACKGROUND

To maintain a vehicle (e.g., an automobile) in optimal driving condition and to avoid damage to the vehicle, certain items should be checked regularly and/or prior to any long trips such as engine oil level, coolant level, brake fluid level, brake pads, tire pressure, headlights, and brake lights. In fact, maintenance activities should be performed periodically to comply with emission standards and traffic laws, and also, to prevent accidents. Typically, stickers are affixed to the windshield or other parts of a vehicle to indicate when the vehicle requires maintenance service. After an oil change, for example, a sticker is affixed to the windshield of an automobile to indicate when the next oil change should be performed. The sticker may indicate that an oil change may be needed after the automobile has been driven for 3,000 miles and/or after three months. Alternatively, some maintenance service providers may send e-mails via the Internet to remind customers of maintenance activities. When the vehicle is not operating properly, the vehicle itself may also provide an audio and/or visual indication of the malfunction. For example, an oil light may indicate that the engine oil level is below a threshold. Government regulations require that a malfunction indicator lamp (MIL) be turned on if one or more emission control systems is not functioning properly.

As mobile technology has advanced in recent years, more and more people are using that technology to arrange and organize their lives. One aspect of designing a wireless device is to provide more convenience for people to perform tasks in everyday life. In particular, people are using wireless devices such as a cellular telephone, a laptop computer, a handheld computer (i.e., a personal digital assistant (PDA)), and a pager to maintain a schedule of day-to-day activities such as daily tasks, appointments, and meetings. For example, a wireless device user may include a list of errands in a to-do list and/or enter a dentist or doctor appointment into a date book stored within the wireless device. Likewise, the user may include an oil change for a vehicle in the to-do list and/or enter a scheduled tune-up of the vehicle into the date book. However, the wireless device is not operable to indicate when the vehicle may require such maintenance services. For example, the vehicle may need an oil change after 3,000 miles have been driven. The brake lights of the vehicle may be burnt out or the vehicle may need more brake fluid are other examples of when the vehicle may require maintenance service that cannot otherwise be scheduled in advance in a datebook. To ensure that the vehicle operates properly, the user may need to be notified and/or reminded of when maintenance service for the vehicle should be performed. Therefore, a need exist for a wireless device to provide a maintenance notification indicating that maintenance service for a vehicle may be necessary.

### BRIEF DESCRIPTION OF THE DRAWINGS

This disclosure will describe several embodiments to illustrate its broad teachings. Reference is also made to the attached drawings.

FIG. 1 is a block diagram representation of a communication system.

FIG. 2 is a block diagram representation of a vehicle.

FIG. 3 is a block diagram representation of a plurality control modules associated with the vehicle.

FIG. 4 is a block diagram representation of a wireless device.

FIG. 5 is a flow diagram illustrating a method for providing a maintenance notification for a maintenance activity associated with a vehicle.

### DETAILED DESCRIPTION

A method and a wireless device for providing a maintenance notification for a maintenance activity associated with a vehicle are described herein. Although the embodiments disclosed herein are particularly well suited for use with a vehicle such as, but not limited to, an automobile, a boat, and a motorcycle, persons of ordinary skill in the art will readily appreciate that the teachings herein are in no way limited to vehicles. On the contrary, persons of ordinary skill in the art will readily appreciate that the teachings can be employed with other devices that require maintenance service such as a computer or a network that requires backup of information, and a water cooler or a furnace that requires filter replacement.

In a wireless communication system, a wireless device may generate a notification request based on a user input so that a vehicle may provide a maintenance notification for a maintenance activity. The wireless device may be, but is not limited to, a cellular telephone, a pager, a personal digital assistant (PDA) (i.e., a handheld computer), and a laptop computer. The notification request may include, but is not limited to, information associated with a trigger event for a maintenance activity associated with a vehicle. For example, the user may request for a maintenance notification for a maintenance activity after the vehicle has been driven a user-selectable number of miles. Alternatively, the wireless device may query the vehicle about maintenance activities by periodically transmitting a notification request. The notification request may also include information associated with a phone number and an e-mail address of a wireless device so that the vehicle may transmit a maintenance notification as described in detail below.

The maintenance activity associated with the vehicle may be, but is not limited to, an oil change, a coolant change, a brake adjustment, a tire pressure adjustment, a fluid replacement, a filter replacement, and a light replacement. Accordingly, the trigger event may be, but is not limited to, a distance driven, a period of time, and a threshold level associated with a vehicle parameter such as oil level, fluid level, engine temperature, engine speed, and vehicle speed. In particular, the notification request may instruct the vehicle to monitor for the trigger event via a control module, and then transmit a maintenance notification upon detection of the trigger event. For example, the wireless device may generate a notification request that instructs the vehicle to monitor the mileage of the vehicle via a powertrain control module (PCM), and to transmit a maintenance notification for an oil change (e.g., via a telematics control module) to the wireless device after 3,000 miles have been driven. The wireless device may also generate a notification request that instructs the vehicle to transmit a maintenance notification for a brake inspection to the wireless device after 25,000 miles have been driven. In another example, the wireless device may generate a notification request that instructs the vehicle to monitor the brake fluid level of the vehicle via an anti-brake system (ABS) control module, and to transmit a maintenance notification to the wireless device upon detection that the brake fluid level is a below the threshold level. Persons of ordinary skill in the art will readily appreciate that a user of the wireless device may generate a notification request for many other maintenance activities associated with a vehicle.

The wireless device may transmit the notification request to the vehicle via a first communication link. The first communication link may be a wired link such that the wireless device and the vehicle may be directly connected via a communication port such as, but not limited to a serial port, a parallel port, and an universal serial bus (USB) port. The first communication link may also be a wireless link such as an infrared link and a radio link between the wireless device and the vehicle. In particular, the wireless device may operate in accordance with a wireless communication protocol such as, but not limited to, a code division multiple access (CDMA) based communication protocol (e.g., WCDMA and CDMA 1×), a time division multiple access (TDMA) based communication protocol, a global system for mobile communication (GSM) based communication protocol, a Bluetooth based communication protocol, an Institute of Electrical and Electronics Engineers (IEEE) 802.11 based communication protocol, a multimedia message service (MMS) communication protocol (e.g., IEEE 802.11b), a short-message service (SMS) communication protocol, and an Infrared Data Association (IrDA) based communication protocol, to transmit the notification request to the vehicle. In a cellular telephone system, for example, the wireless device may indirectly transmit the notification request to the vehicle. That is, the wireless device may transmit the notification request to a base station within the cellular telephone system, which in turn, may transmit the notification request to the vehicle.

As mentioned above, the vehicle may include a plurality of control modules (e.g., a telematics control module, an anti-brake system (ABS) control module, a powertrain control module (PCM), a body control module (BCM) module, a supplemental restraint system (SRS) control module, and a radio control module) to monitor for a trigger event specified in the notification request so that the vehicle may transmit a maintenance notification to the wireless device. Upon detection of the trigger event by the vehicle, the wireless device receives the maintenance notification from the vehicle via a second communication link. For example, the wireless device may receive the maintenance notification from the vehicle via a wireless link as described above. The vehicle may also transmit the maintenance notification to other wireless devices as well, e.g., a secondary wireless device, a spouse's wireless device, etc. The maintenance notification may be, but is not limited to, a graphical image (e.g., an icon), a sound indication (e.g., an alarm), a visual indication (e.g., a blinking and/or flashing light), a text message, an audio message, a video message, and a multimedia message. Thus, the user of the wireless device may be notified and/or reminded that a maintenance service is required. Alternatively, the wireless device may store the maintenance notification as an entry in a date book within the wireless device. For example, the user may be notified and/or reminded at a future date to schedule for maintenance service. The user may also forward the maintenance notification to a service center to schedule an appointment, to another person to serve as a reminder, etc. Nonetheless, the user may simply ignore (i.e., snooze) and/or delete the maintenance notification.

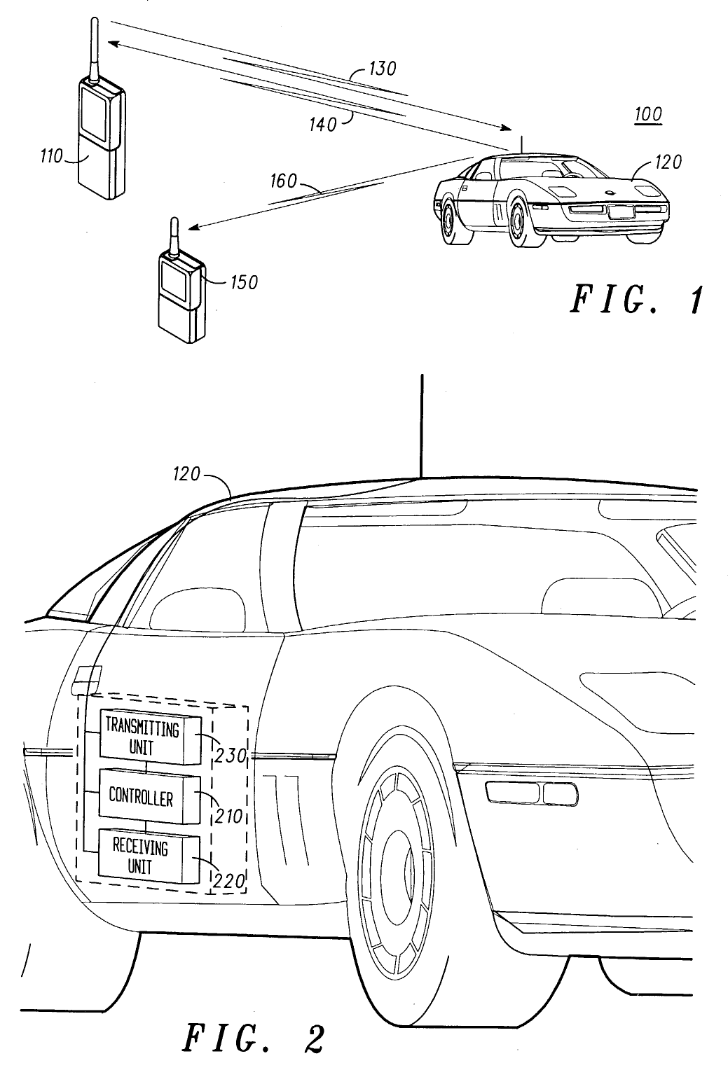

Referring to FIG. 1, a wireless communication system 100 generally includes a wireless device 110 and a vehicle 120. The wireless device 110 may be, but is not limited to, a cellular telephone, a pager, a personal digital assistant (PDA), and a laptop computer. Although the embodiments disclosed herein are particularly well suited for use with vehicles such as an automobile, a boat, and a motorcycle, persons of ordinary skill in the art will readily appreciate that the teachings herein are in now way limited to those vehicles. On the contrary, persons of ordinary skill in the art will readily appreciate that the teachings can be employed with other devices such as a computer, a network, a water cooler, and a furnace.

As explained in detail below, the wireless device 110 is in communication with the vehicle 120 via a first communication link 130, which may be a wired link and/or a wireless link to transmit a notification request to the vehicle 120. Referring to FIG. 2, the vehicle 120 generally includes a controller 210, a receiving unit 220, and a transmitting unit 230. The receiving unit 220 and the transmitting unit 230 are operatively coupled to the controller 210. Persons of ordinary skill in the art will readily appreciate that the receiving unit 220 and the transmitting unit 230 may be separate components or integrated into a single component. For example, the receiving unit 220 and the transmitting unit 230 may be integrated into a single transceiver unit operable to receive a notification request from the wireless device 110 and to transmit a maintenance notification to the wireless device 110.

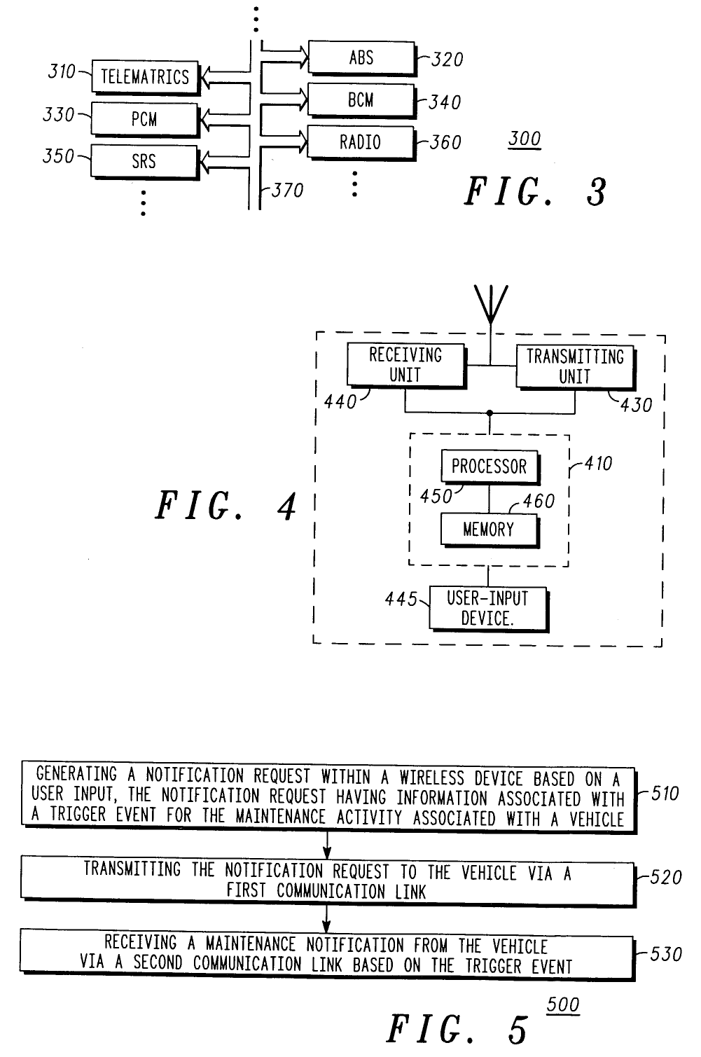

During an initial setup, the wireless device 110 may retrieve information associated with the detection capability of the vehicle 120, i.e., the trigger event(s) that the vehicle 120 may be operable to monitor. Persons of ordinary skill in the art will readily appreciate that the wireless device 110 may retrieve such information in many ways. For example, the wireless device 110 may directly query the vehicle 120 for its detection capability. Alternatively, the wireless device 110 may access the website for the vehicle's manufacturer and download the detection capability information via the Internet, i.e., from a server of the vehicle's manufacturer. In particular, the controller 210 of the vehicle 120 may be operable to monitor for a trigger event specified in the notification request from the wireless device 110. The controller 210 may include a plurality of control modules 300 (shown in FIG. 3) such as, but not limited to, a telematics control module 310, an anti-brake system (ABS) control module 320, a powertrain control module (PCM) 330, a body control module (BCM) 340, a supplemental restraint system (SRS) control module 350, and a radio control module 360, as persons of ordinary skill in the art will readily recognize. The plurality of control modules 300 may be operatively coupled together via a communication bus 370 or a packet data network (not shown). The plurality of control modules 300 may be operable to monitor for the trigger event specified in the notification request. For example, the PCM 330 may monitor the distance driven on the vehicle 120. In another example, the BCM 340 may monitor the battery level of the vehicle 120. The controller 210 (e.g., via the transmitting unit 230) may transmit information associated with the plurality of control modules 300 to the wireless device 110 so that the user may be informed of the detection capability of the vehicle 120.

Upon receipt of the information associated with the plurality of control modules 300 of the vehicle 120, the wireless device 110 may provide the vehicle 120 with a notification request based on a user input. For example, a user may request for a maintenance notification after the vehicle 120 has been driven for 3,000 miles. Alternatively, the wireless device 110 may automatically query the vehicle 120 for a maintenance notification by periodically transmitting a notification request. The wireless device 110, for example, may provide the vehicle with a notification request once a week. In either case, the vehicle 120 (e.g., via the receiving unit 220) may receive the notification request from the wireless device 110 via the first communication link 130 shown in FIG. 1. The notification request may also include information associated with, but not limited to, a phone number and an e-mail address of the wireless device 110 itself and/or another wireless device (e.g., one shown as 150 in FIG. 1). That is, the wireless device 110 may set the vehicle 120 with the notification request to transmit the maintenance notification to the first wireless device 1O itself and/or a second wireless device (i.e., the wireless device 150). For example, a first wireless device (i.e., the wireless device 110) may transmit a notification request to the vehicle 120, and a second wireless device 150 may receive the maintenance notification via a communication link 160 in response to the vehicle 120 detecting a trigger event specified in a notification request from the first wireless device 110.

Upon detection of a trigger event by one of the plurality of control modules 300 as described above, the vehicle 120 (e.g., via the telematics control module 310 and the transmitting unit 230) may transmit a maintenance notification to the wireless device 110 via the second communication link 140. In particular, the second communication link 140 may be a wireless link such as, but not limited to, an infrared link and a radio link. To communicate via a wireless link, the vehicle 120 may operate in accordance with a wireless communication protocol such as, but not limited to, one of a code division multiple access (CDMA) based communication protocol, a time division multiple access (TDMA) based communication protocol, a global system for mobile communication (GSM) based communication protocol, a Bluetooth based communication protocol, an Institute of Electrical and Electronics Engineers (IEEE) 802.11 based communication protocol, a multimedia message service (MMS) communication protocol, a short-message service (SMS) communication protocol, and an Infrared Data Association (IrDA) based communication protocol. In accordance with a Bluetooth based communication protocol, for example, the vehicle 120 may transmit the maintenance notification directly to the wireless device 110. Alternatively, the vehicle 120 may indirectly transmit the maintenance notification to the wireless device 110. In a cellular telephone system as persons of ordinary skill in the art will readily recognize, for example, the vehicle 120 may transmit the maintenance notification to a base station within the cellular telephone system, which in turn, may transmit the maintenance notification to the wireless device 110.

Referring to FIG. 4, a wireless device 110 adapted to provide a maintenance notification for a maintenance activity associated with a vehicle 120 is shown. The wireless device 110 generally includes a controller 410, a transmitting unit 430, a receiving unit 440, and a user input device 445. The controller 410 includes a processor 450 and a memory 460. The processor 450 is operatively coupled to the memory 460, which stores a program or a set of operating instructions for the processor 450. The processor 450 executes the program or the set of operating instructions such that the electronic device 110 operates as described herein. The program of the set of operating instructions may be embodied in a computer-readable medium such as, but not limited to, paper, a programmable gate array, an application specific integrated circuit (ASIC), an erasable programmable read only memory (EPROM), a read only memory (ROM), a random access memory (RAM), a magnetic media, and an optical media. The controller 410 is operatively coupled to the transmitting unit 430 and the receiving unit 440. Persons of ordinary skill in the art will readily appreciate that the transmitting unit 430 and the receiving unit 440 may be separate components or integrated into a single component, e.g., a transceiver unit. Further, the controller 410 is operatively coupled to the user input device 445, which may be, but is not limited to, a keyboard, a numeric keypad, an alphanumeric keypad, a touch-sensitive display, and a microphone.

A basic flow for providing a maintenance notification for a maintenance activity associated with a vehicle that may be applied with the wireless device shown in FIG. 4 may start with the wireless device 110 (e.g., via the controller 410) generating a notification request based on a user input via the user input device 445. The notification request may include information associated with a trigger event for a maintenance activity associated with a vehicle. The notification request may also include information associated with a wireless device such as, but not limited to, a phone number and an e-mail address of the wireless device so that vehicle may be operable to communicate with the wireless device. The trigger event may be, but is not limited to, a distance driven, a period of time, and a threshold level associated with a vehicle parameter that the vehicle may monitor via the plurality of control modules 300 or an existing maintenance reminder system. That is, information associated with the trigger event may be the mileage driven or the time elapsed since the last maintenance service on the vehicle. Information associated with the trigger event may also be a minimum level or a maximum level of a particular vehicle parameter. In particular, the vehicle parameter may be, but is not limited to, oil level, fluid level, vehicle speed, engine speed, and engine temperature. Persons of ordinary skills in the art will readily appreciate that the maintenance activity associated with the vehicle may include a variety of maintenance service to ensure that the vehicle is operating properly. For example, the maintenance activity associated with the vehicle may be, but is not limited to, an oil change, a coolant change, a brake adjustment, a tire pressure adjustment, a fluid replacement, a filter replacement, and a light replacement.

To illustrate the concept of a trigger event for a maintenance activity, the controller 410 of the wireless device 110 may generate a notification request for a maintenance notification to notify and/or remind the user of the vehicle that an oil change may be necessary after the vehicle has been driven for 3,000 miles. Alternatively, the controller 410 may generate a notification request for a maintenance notification to notify and/or remind the user to get an oil change three months after the last oil change. In another example, the controller 410 may generate a notification request for a maintenance notification in response to the brake fluid of the vehicle being below a minimum level. Persons of ordinary skill in the art will appreciate that a notification request may be implemented for many other maintenance activities associated with a vehicle.

The wireless device 110 (e.g., via the transmitting unit 430) sends the notification request to the vehicle 120 via the first communication link 130 as described above. In response to receipt of the notification request from the wireless device 110, the vehicle 120 monitors for the trigger event via the plurality of control modules 300 as persons of ordinary skill in the art will readily appreciate. For example, the notification request may be sent to an existing reminder maintenance system within the vehicle 120. Upon detection of the trigger event, the vehicle 120 transmits a maintenance notification to the wireless device 110. Accordingly, the wireless device 110 (e.g., via the receiving unit 440) receives the maintenance notification via the second communication link 140. The maintenance notification may be, but is not limited to, a graphical image (e.g., an icon), a sound indication (e.g., an alarm), a visual indication (e.g., a blinking and/or flashing light), a text message, an audio message, a video message, and a multimedia message. As a result, the user of the wireless device 110 may be notified and/or reminded that a maintenance activity associated with the vehicle should be performed.

One possible implementation of the computer program executed by the wireless device 110 (e.g., via the processor 450) is illustrated in FIG. 5. Persons of ordinary skill in the art will appreciate that the computer program can be implemented in any of many different ways utilizing any of many different programming codes stored on any of many computer-readable mediums such as a volatile or nonvolatile memory or other mass storage device (e.g., a floppy disk, a compact disc (CD), and a digital versatile disc (DVD)). Thus, although a particular order of steps is illustrated in FIG. 5, persons of ordinary skill in the art will appreciate that these steps can be performed in other temporal sequences. Again, the flow chart 500 is merely provided as an example of one way to program the wireless device 110 to provide a maintenance notification for a maintenance activity associated with a vehicle. The flow chart 500 begins at step 510, wherein the wireless device 110 generates a notification request based on a user input. The notification request may include, but is not limited to, information associated with a trigger event for a maintenance activity associated with a vehicle. For example, the wireless device 110 may request for a maintenance notification for an oil change from the vehicle after 3,000 miles have been driven. In another example, the wireless device 110 may request for a maintenance notification for a brake inspection after six months since the last inspection. The notification request may also include information such as, but not limited to, a phone number and an e-mail address associated with the wireless device and/or a secondary wireless device. For example, the vehicle may also transmit the maintenance notification to a spouse's wireless device. As noted above, the wireless device 110 may retrieve information associated with a plurality of control modules of the vehicle prior to generating the notification request so that the user may informed of the vehicle's detection capability, i.e., the trigger event(s) that the vehicle is operable to monitor via the plurality of control modules.

At step 520, the wireless device 110 transmits the notification request to a vehicle via a wired link or a wireless link. The vehicle monitors for the trigger event specified in the notification request via a plurality of control modules as persons of ordinarily skill in the art will readily appreciate. Upon detection of the trigger event, the vehicle transmits a maintenance notification to the wireless device 110 via a wireless link. That is, the wireless device 110 at step 530 receives a maintenance notification for a maintenance activity associated with the vehicle. For example, the vehicle may detect that the brake fluid is below a minimum threshold. Accordingly, the wireless device 110 may receive a text message stating that the brake system may require maintenance service. Further, the wireless device 110 may store the maintenance notification in a date book stored within the wireless device 110. As a result, the user of the vehicle is notified and/or reminded of a maintenance activity for the vehicle.

Many changes and modifications to the embodiments described herein could be made. The scope of some changes is discussed above. The scope of others will become apparent from the appended claims.

What is claimed is:

1. In a wireless communication system, wherein a vehicle is operable to detect a trigger event, a method for providing a maintenance notification for a maintenance activity associated with the vehicle, the method comprising:
generating a notification request within a wireless device based on a user input, the notification request having information associated with the trigger event for the maintenance activity associated with the vehicle;
transmitting the notification request to the vehicle via a first communication link; and
receiving a maintenance notification from the vehicle via a second communication link based on the trigger event.

2. The method of claim 1, wherein the step of generating a notification request within a wireless device based on a user input comprises generating a notification request within one of a cellular telephone, a personal digital assistant (PDA), a pager, and a laptop computer.

3. The method of claim 1, wherein the step of generating a notification request within a wireless device based on a user input comprises generating a notification request having information associated with a trigger event for one of an oil change, a coolant change, a brake adjustment, a tire pressure adjustment, a fluid replacement, a filter replacement, and a light replacement.

4. The method of claim 1, wherein the step of transmitting the notification request to the vehicle via a first communication link comprises transmitting the notification request to one of an automobile, a boat, and a motorcycle via a first communication link.

5. The method of claim 1, wherein the step of transmitting the notification request to the vehicle via a first communication link comprises transmitting the notification request to the vehicle via one of a wireless link, wherein the wireless link operates in accordance with one of a code division multiple access (CDMA) based communication protocol, a time division multiple access (TDMA) based communication protocol, a global system for mobile communication (GSM) based communication protocol, a Bluetooth communication protocol, a multimedia message service (MMS) communication protocol, and a short-message service (SMS) communication protocol, and an Infrared Data Association (IrDA) based communication protocol.

6. The method of claim 1, wherein the step of receiving a maintenance notification from the vehicle via a second communication link based on the trigger event comprises receiving a maintenance notification from the vehicle via a second communication link in response to detection of the trigger event by the vehicle.

7. The method of claim 1, wherein the step of receiving a maintenance notification from the vehicle via a second communication link comprises receiving a maintenance notification based on one of a distance driven, a period of time, and a threshold level associated with a vehicle parameter.

8. The method of claim 1, wherein the wireless device is a first wireless device, and wherein the step of receiving a maintenance notification from the vehicle via a second communication link based on the trigger event comprises receiving a maintenance notification within a second wireless device from the vehicle via a second communication link based on the trigger event.

9. The method of claim 1, wherein the step of receiving a maintenance notification from the vehicle via a communication link comprises receiving a maintenance notification from the vehicle via a wireless link, the wireless link operates in accordance with one of a code division multiple access (CDMA) based communication protocol, a time division multiple access (TDMA) based communication protocol, a global system for mobile communication (GSM) based communication protocol, a Bluetooth communication protocol, a multimedia message service (MMS) communication protocol, a short-message service (SMS) communication protocol and an Infrared Data Association (IrDA) based communication protocol.

10. The method of claim 1 further comprising the step of storing the maintenance notification in a date book stored within the wireless device.

11. The method of claim 1 further comprising the steps of:
retrieving information associated with detection capability of the vehicle within the wireless device; and
providing the information associated with detection capability of the vehicle within the wireless device to a user.

12. A wireless device for providing a maintenance notification for a maintenance activity associated with a vehicle, the wireless device comprising:
a user-input device;
a controller operatively coupled to the user-input device, the controller having a processor and a memory operatively coupled to the processor,
the controller being programmed to generate a notification request based on a user input via the user-input device, the notification request having information associated with a trigger event for a maintenance activity associated with the vehicle;
a transmitting unit operatively coupled to the controller, the transmitting unit being operable to transmit the notification request to the vehicle via a first communication link; and
a receiving unit operatively coupled to the controller, the receiving unit being operable to receive a maintenance notification from the vehicle via a second communication link based on the trigger event.

13. The wireless device of claim 12 is one of a cellular telephone, a pager, a personal digital assistant (PDA), and a laptop computer.

14. The wireless device of claim 12, wherein the vehicle is one of an automobile, a boat, and a motorcycle.

15. The wireless device of claim 12, wherein the maintenance activity associated with the vehicle is one of an oil change, a coolant change, a brake adjustment, a tire adjustment, a fluid replacement, a filter replacement, and a light replacement.

16. The wireless device of claim 12, wherein the trigger event is one of a distance driven, a period of time, and a threshold level associated with a vehicle parameter.

17. The wireless device of claim 12, wherein the notification request comprises information associated with one of a phone number and an e-mail address of a wireless device.

18. The wireless device of claim 12, wherein the maintenance notification is one of a graphical image, a sound indication, a visual indication, a text message, an audio message, and a video message, and a multimedia message.

19. The wireless device of claim 12, wherein the controller is operable to store the maintenance notification in a date book stored within the memory.

20. The wireless device of claim 12 operates in accordance with one of a code division multiple access (CDMA) based communication protocol, a time division multiple access (TDMA) based communication protocol, a global service for mobile communications (GSM) based communication protocol, a Bluetooth communication protocol, a multimedia message service (MMS) communication protocol, a short-message service (SMS) communication protocol, and an Infrared Data Association (IrDA) based communication protocol.

21. In a wireless communication system, wherein a processor operates in accordance with a computer program embodied on a computer-readable medium for providing a maintenance notification for a maintenance activity associated with a vehicle, the computer program comprising:
a first routine that directs the processor to generate a notification request within a wireless device based on a user input, the notification request having information associated with a trigger event for a maintenance activity associated with the vehicle;
a second routine that directs the processor to transmit the notification request to the vehicle via a first communication link; and
a third routine that directs the processor to receive a maintenance notification from the vehicle via a second communication link based on the trigger event.

22. The computer program of claim 21, wherein the first routine comprises a routine that directs the processor to generate a notification request within one of a cellular telephone, a personal digital assistant (PDA), a pager, and a laptop computer.

23. The computer program of claim 21, wherein the first routine comprises a routine that directs the processor to generate a notification request having information associated with a trigger event for one of an oil change, a coolant change, a brake adjustment, a tire pressure adjustment, a fluid replacement, a filter replacement, and a light replacement.

24. The computer program of claim 21, wherein the second routine comprises a routine that directs the processor to transmit the notification request to one of an automobile, a boat, and a motorcycle via a first communication link.

25. The computer program of claim 21, wherein the second routine comprises a routine that directs the processor to transmit the notification request to the vehicle via a wireless link, wherein the wireless link operates in accordance with one of a code division multiple access (CDMA) based communication protocol, a time division multiple access (TDMA) based communication protocol, a global system for mobile communication (GSM) based communication protocol, a Bluetooth communication protocol, a multimedia message service (MMS) communication protocol, a short-message service (SMS) communication protocol, and an Infrared Data Association (IrDA) based communication protocol.

26. The computer program of claim 21, wherein the third routine comprises a routine that directs the processor to receive a maintenance notification based on one of a distance driven, a period of time, and a threshold level associated with a vehicle parameter.

27. The computer program of claim 21, wherein the third routine comprises a routine that directs the processor to receive a maintenance notification from the vehicle via a wireless link, the wireless link operates in accordance with one of a code division multiple access (CDMA) based communication protocol, a time division multiple access (TDMA) based communication protocol, a global system for mobile communication (GSM) based communication protocol, a Bluetooth communication protocol, a multimedia message service (MMS) communication protocol, a short-message service (SMS) communication protocol, and an Infrared Data Association (IrDA) based communication protocol.

28. The computer program of claim 21 further comprising a fourth routine that directs the processor to store the maintenance notification in a date book stored within the wireless device.

29. The computer program of claim 21, wherein the medium is one of paper, a programmable gate array, application specific integrated circuit, erasable programmable read only memory, read only memory, random access memory, magnetic media, and optical media.

30. In a wireless communication system, wherein a vehicle is operable to detect a trigger event, a method for providing a maintenance notification for a maintenance activity associated with the vehicle, the method comprising:
retrieving information associated with detection capability of the vehicle within a first device;
providing the information associated with detection capability of the vehicle within the first device to a user;
generating a notification request within the first device based on a user input, the notification request having information associated with the trigger event for the maintenance activity associated with the vehicle and information associated with a second device, the second device being a wireless device;
transmitting the notification request to the vehicle via a first communication link so that the vehicle is operable to transmit a maintenance notification to one of the first device and the second device via a second communication link upon detection of the trigger event by the vehicle.
